(19) United States
(12) Patent Application Publication
(10) Pub. No.: US 2025/0123175 A1
(43) Pub. Date: Apr. 17, 2025

(54) VACUUM BELLOWS INTEGRITY VALIDATION TOOL

(71) Applicant: FERMI RESEARCH ALLIANCE, LLC, Batavia, IL (US)

(72) Inventors: Timothy Warren Hamerla, Brunswick, GA (US); Richard Allan Andrews, Batavia, IL (US); Zuxing Chen, Naperville, IL (US)

(21) Appl. No.: 18/912,327

(22) Filed: Oct. 10, 2024

Related U.S. Application Data
(60) Provisional application No. 63/544,093, filed on Oct. 13, 2023.

(51) Int. Cl. G01M 3/04

(52) U.S. Cl. CPC G01M 3/04

(57) ABSTRACT

A vacuum bellows integrity validation tool comprises two first side gripper plates mounted to a first support plate, two second side gripper plates mounted to a second support plate, and a separator dowel configured to engage the first support plate and the second plate.

### CROSS-REFERENCE TO RELATED PATENT APPLICATIONS

This patent application claims the priority and benefit under 35 U.S.C. § 119(e) of U.S. Provisional Patent Application Ser. No. 63/544,093 filed Oct. 13, 2023, entitled “VACUUM BELLOWS INTEGRITY VALIDATION TOOL.” U.S. Provisional Patent Application Ser. No. 63/544,093 is herein incorporated by reference in its entirety.

### STATEMENT OF GOVERNMENT RIGHTS

The invention described in this patent application was made with Government support under the Fermi Research Alliance, LLC, Contract Number DE-AC02-07CH11359 awarded by the U.S. Department of Energy. The Government has certain rights in the invention.

### TECHNICAL FIELD

The embodiments are generally related to the field of testing equipment. Embodiments further relate to the field of bellows. Embodiments are also related to testing devices for vacuum bellows. Embodiments are further related to vacuum validation tools for use in bellows.

### BACKGROUND

Bellows are well understood mechanical devices used to provide flexible connection of common spaces in between two rigid bodies for expansions or mobility. Metal bellows are widely used in various fields including hydraulic systems, aerospace applications, energy applications, semiconductor fabrication, petrochemical applications, and cryogenics.

For example, in certain applications metal bellows are used in particle accelerator beamlines to connect various accelerator devices and allow some degree of flexibility for maintaining alignment between accelerator components. Metal bellows, welded to sections of tubing, are an ideal solution for connecting these components.

It is advisable for the vacuum integrity of the bellows to be determined before installation for such applications. Even very small leaks in the bellows can have catastrophic consequences. Normally vacuum integrity checking is done before welding the bellows into the sub-assembly. However, such techniques can produce dubious results. The nature of a bellows form can hide leaks in the folds or leaves of the bellows, which can make it extraordinarily difficult to detect leaks when the bellows is in a retracted position. When the bellows is in a retracted position the folds of the bellows may touch one another, masking leaks that may exist therein. As such, it would be preferrable to extend the bellows for testing. Unfortunately, there is currently no simple solution to this problem.

Another option is for vacuum integrity in bellows to be tested after welding the bellows to the tubing and flange. It is not uncommon to discover vacuum leaks in bellows after assembly. If a leak is detected the system must be dissembled. Such repairs are a major inconvenience. The procedure to repair or replace a defective bellows is both time consuming and costly. The need to create a more robust and secure mechanism for assuring the soundness of these bellows before assembly is a high priority.

As such, there is a need in the art for systems and methods for testing vacuum bellows integrity, as disclosed herein.

### SUMMARY

The following summary is provided to facilitate an understanding of some of the innovative features unique to the embodiments disclosed and is not intended to be a full description. A full appreciation of the various aspects of the embodiments can be gained by taking the entire specification, claims, drawings, and abstract as a whole.

It is, therefore, one aspect of the disclosed embodiments to provide for testing vacuum integrity in a bellows.

It is another aspect of the disclosed embodiments to provide a method for testing bellows.

It is another aspect of the disclosed embodiments to provide a tool for testing vacuum integrity in metal welded bellows.

The aforementioned aspects and other objectives and advantages can now be achieved as described herein. In an embodiment, a system comprises at least one first side gripper plate mounted to a first support plate, at least one second side gripper plate mounted to a second support plate, and a separator dowel configured to engage the first support plate and the second plate. In an embodiment, the separator dowel comprises a threaded dowel. In an embodiment, the at least one first gripper plate comprises two first side gripper plates. In an embodiment, the at least one second gripper plate comprises two second side gripper plates. In an embodiment, each of the first side gripper plate and the second side gripper plate comprise a lip. In an embodiment, the lip is configured to engage an interior of a bellows. In an embodiment, the system further comprises at least one connector configured to attach the at least one first side gripper plate to the first support plate and at least one connector configured to attach the at least one second side gripper plate to the second support plate. In an embodiment, rotating the separator dowel separates the first support plate and the second support plate.

In an embodiment, a validation tool comprises at least one first side gripper plate mounted to a first support plate, the first support plate comprising a female threaded receiving port, at least one second side gripper plate mounted to a second support plate, the second support plate comprising a female threaded receiving port, and a threaded separator dowel configured to engage the female threaded receiving port of the first support plate and the female threaded receiving port of the second support plate. In an embodiment, rotation of the threaded separator dowel moves the first support plate and the second support plate away from one another. In an embodiment, the at least one first gripper plate comprises two first side gripper plates, and the at least one second gripper plate comprises two second side gripper plates. In an embodiment, each of the first side gripper plate and the second side gripper plate comprise a lip configured to engage an interior of a bellows. In an embodiment, the validation tool further comprises at least one connector configured to attach the at least one first side gripper plate to the first support plate and at least one connector configured to attach the at least one second side gripper plate to the second support plate. In an embodiment, the validation tool is configured to fit inside a bellows.

In an embodiment, a method for validating bellows vacuum integrity with a tool comprises inserting a tool into a bellows, the tool comprising: at least one first side gripper plate mounted to a first support plate, the first support plate comprising a female threaded receiving port, at least one second side gripper plate mounted to a second support plate, the second support plate comprising a female threaded receiving port, and a threaded separator dowel configured to engage the female threaded receiving port of the first support plate and the female threaded receiving port of the second support plate; expanding the bellows with the tool; drawing a vacuum in the bellows; and identifying leaks in the bellows. In an embodiment, expanding the bellows with the tool comprises rotating the threaded separator dowel. In an embodiment, identifying leaks in the bellows comprises identifying leaks in the bellows with a mass spectrometer leak detector. In an embodiment, the method for validating bellows vacuum integrity with a tool further comprises engaging a lip of the tool onto an interior of the bellows. In an embodiment, the method for validating bellows vacuum integrity with a tool further comprises releasing the vacuum inside the bellows. In an embodiment, the method for validating bellows vacuum integrity with a tool further comprises removing the tool from the bellows.

### BRIEF DESCRIPTION OF THE FIGURES

The accompanying figures, in which like reference numerals refer to identical or functionally similar elements throughout the separate views and which are incorporated in and form a part of the specification, further illustrate the embodiments and, together with the detailed description, serve to explain the embodiments disclosed herein.

FIG. 1 illustrates a bellows vacuum integrity validation tool, in accordance with the disclosed embodiments;

FIG. 2A illustrates a cross-section of the bellows vacuum integrity validation tool, in accordance with the disclosed embodiments;

FIG. 2B illustrates a cross-section of the bellows vacuum integrity validation tool, in accordance with the disclosed embodiments;

FIG. 3 illustrates a cross-section of a bellows vacuum integrity validation tool installed in a bellows, in accordance with the disclosed embodiments; and

FIG. 4 illustrates a method for extending a bellows with a bellows vacuum integrity validation tool, in accordance with the disclosed embodiments.

### DETAILED DESCRIPTION

The particular values and configurations discussed in the following non-limiting examples can be varied, and are cited merely to illustrate one or more embodiments, and are not intended to limit the scope thereof.

Example embodiments will now be described more fully hereinafter with reference to the accompanying drawings, in which illustrative embodiments are shown. The embodiments disclosed herein can be embodied in many different forms and should not be construed as limited to the embodiments set forth herein. Rather, these embodiments are provided so that this disclosure will be thorough and complete, and will fully convey the scope of the embodiments to those skilled in the art. Like reference numerals refer to like elements throughout.

The terminology used herein is for the purpose of describing particular embodiments only and is not intended to be limiting. As used herein, the singular forms “a,” “an,” and “the” are intended to include the plural forms as well, unless the context clearly indicates otherwise. It will be further understood that the terms “comprises” and/or “comprising,” a used in this specification, specify the presence of stated features, integers, steps, operations, elements, and/or components, but do not preclude the presence or addition of one or more other features, integers, steps, operations, elements, components, and/or groups thereof.

Throughout the specification and claims, terms may have nuanced meanings suggested or implied in context beyond an explicitly stated meaning. Likewise, the phrase “in one embodiment” as used herein does not necessarily refer to the same embodiment and the phrase “In another embodiment” as used herein does not necessarily refer to a different embodiment. It is intended, for example, that claimed subject matter include combinations of example embodiments in whole or in part.

Unless otherwise defined, all terms (including technical and scientific terms) used herein have the same meaning as commonly understood by one of ordinary skill in the art. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

It is contemplated that any embodiment discussed in this specification can be implemented with respect to any method, kit, reagent, or composition of the invention, and vice versa. Furthermore, compositions of the invention can be used to achieve methods of the invention.

It will be understood that particular embodiments described herein are shown by way of illustration and not as limitations. The principal features can be employed in various embodiments without departing from the scope disclosed herein. Those skilled in the art will recognize, or be able to ascertain, using no more than routine experimentation, numerous equivalents to the specific procedures described herein. Such equivalents are considered to be within the scope of the disclosed embodiments and are covered by the claims.

The use of the word “a” or “an” when used in conjunction with the term “comprising in the claims and/or the specification may mean “one,” but it is also consistent with the meaning of “one or more,” at “at least one,” and “one or more than one.” The use of the term “or” in the claims is used to mean “and/or” unless explicitly indicated to refer to alternatives only or the alternatives are mutually exclusive, although the disclosure supports a definition that refers to only alternatives and “and/or.” Throughout this application, the term “about” is used to indicate that a value includes the inherent variation of error for the device, the method being employed to determine the value, or the variation that exists among the study subjects.

As used in this specification and claim(s), the words “comprising” (and any form of comprising, such as “comprise” and “comprises”), “having” (and any form of “having,” such as “have” and “has”), “including” (and any form of “including,” such as “includes” and “include”) or “containing” (and any form of “containing,” such as “contains” and “contain”) are inclusive or open-ended and do not exclude additional, un-recited elements or method steps.

All of the compositions and/or methods disclosed and claimed herein can be made and executed without undue experimentation in light of the present disclosure. While the compositions and methods have been described in terms of preferred embodiments, it will be apparent to those of skill in the art that variations may be applied to the compositions and/or methods and in the steps, or in the sequence of steps, of the method described herein without departing from the concept, spirit, and scope of the disclosed embodiments. All such similar substitutes and modifications apparent to those skilled in the art are deemed to be within the spirit, scope and concept as defined by the appended claims.

Metal bellows in ultra-high vacuum applications may experience leaks after being welded into an assembly. Although these leaks may become apparent after installation, it is not uncommon for the leak to exist, undetected before installation. The disclosed embodiments are directed to an inspection technique and tool configured to allow the leaves of the bellows to remain in a neutral state while an internal vacuum is drawn. A mass spectrometer leak detector can then be attached so that any leaks in the bellows can be identified.

In certain embodiments, a mechanical validation tool is configured to maintain the design dimension of welded edge metal bellows assemblies, so that the bellows assembly can be tested for vacuum integrity. The tool is configured to prevent the collapse of the bellows due to a vacuum pressure load during testing. The tool is configured to allow for accurate vacuum leak checking of the bellows' welded joints, including both inside and outside welds, before the metal bellows assembly is put into service.

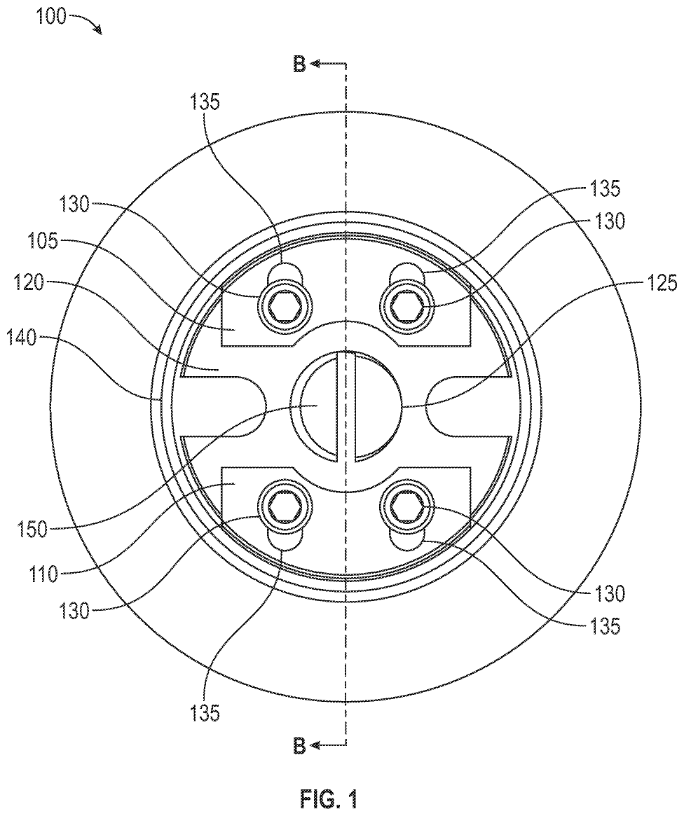

FIG. 1 illustrates a validation tool 100 configured to allow the leaves of the bellows to remain in a neutral state while an internal vacuum is drawn, in accordance with the disclosed embodiments. FIG. 1 shows a head on view of the tool 100 in a bellows.

The tool 100 can include a first gripper plate 105 and a second gripper plate 110 on a first end 140 and commensurate gripper plates (not visible in FIG. 1) on the other end of the tool 100. Each gripper plate includes a lip configured to overlap with, and create a base of support for, the outer most bellows fold as further detailed herein.

The gripper plates 105 and 110 respectively can be mounted to a female threaded support plate 120. The support plate 120 can include a through hole 125 with female threads configured to accept a separator dowel 150. In certain embodiments, the through hole 125 can be formed in the center of the support plate. The support plate 120 can further include a first side cutout 155 and a second side cutout 160.

The diameter of the through hole 125 can be selected to operably engage with the separator dowel 150 so that the rotation of the separator dowel 150 will move the first end 140 of the tool away from, or towards, the second end of the tool. In this way, the rotation of the separator dowel 150 allows for highly precise adjustment of the separation of the leaves in the bellows for vacuum integrity testing.

The support plate 120 can be mounted to the first gripper plate 105 and the second gripper plate 110 with connectors 130 configured to be engaged through mounting holes 135. The connectors 130 can comprise bolts and nuts, or another such threaded connectors.

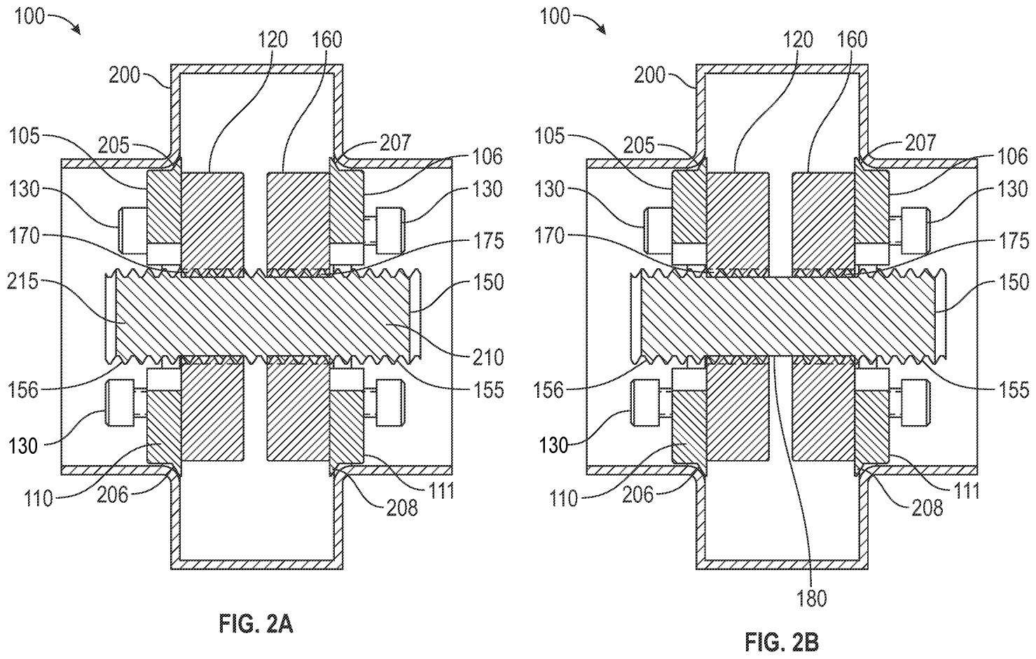

FIG. 2A and FIG. 2B illustrate a cross-section along the line B-B illustrated in FIG. 1. This illustrates the connection between the bellows 200 and the lip 205, lip 206, lip 207, and lip 208 on the gripper plate 105, gripper plate 106, gripper plate 110, and gripper plate 111 respectively, in accordance with the disclosed embodiments.

The tool 100 further includes a separator dowel 150. The separator dowel 150 is configured into two segments, a first segment 210 with right handed threading 155, and a second segment 215 with left handed threading 156.

The first support plate 120 includes matching left handed threading 170 configured to engage the right handed threading 156 on the second segment 215 of the separator dowel 150. Likewise, the support plate 160 mounted to gripper plate 106 and gripper plate 111, can include right handed threading 175 configured to engage with right handed threading 155 on the first segment 210 of the separator dowel 150.

The two segments of the dowel 150, with opposite handed threads, are configured so that rotation of the separator dowel 150 in one direction will move support plate 120 and support plate 160 away from each other. Likewise, rotation of the separator dowel 150 in the opposite direction will move support plate 120 and support plate 160 toward each other.

This allows the tool to be used to adjust the bellows to be expanded to an optimal test length, with fine precision. FIG. 2B illustrates another exemplary cross sectional view of the validation tool, where the double ended dowel 150 includes a thread break 180 between the left handed threading 156 and right handed threading 155.

The lips on the gripper plates are configured to engage the inside corners of the bellows 200. In certain embodiments, the lips can engage the first inner corners of the leaves of the bellows 200, although it is possible to engage with lips with other inside corners.

Once all the respective gripper plates 105, 110, 106, and 111 are adequately engaged in place with the lips in place on the bellows, the separator dowel 150 can be rotated. As the separator dowel 150 is rotated, the threading will move the support plate 120 and the second support plate 160 away from one another. As the support plates move away from one another, the lips engaged to the bellows 200 force the bellows' 200 leaves to extend (or contract depending on the directions of rotation). The tool 100 can be used to open the leaves of the bellows 200 sufficiently so that when a vacuum is drawn, all the folds in the bellows are exposed and leaks can be detected. Furthermore, the tool 100 prevents the bellows from collapsing from vacuum pressure during testing.

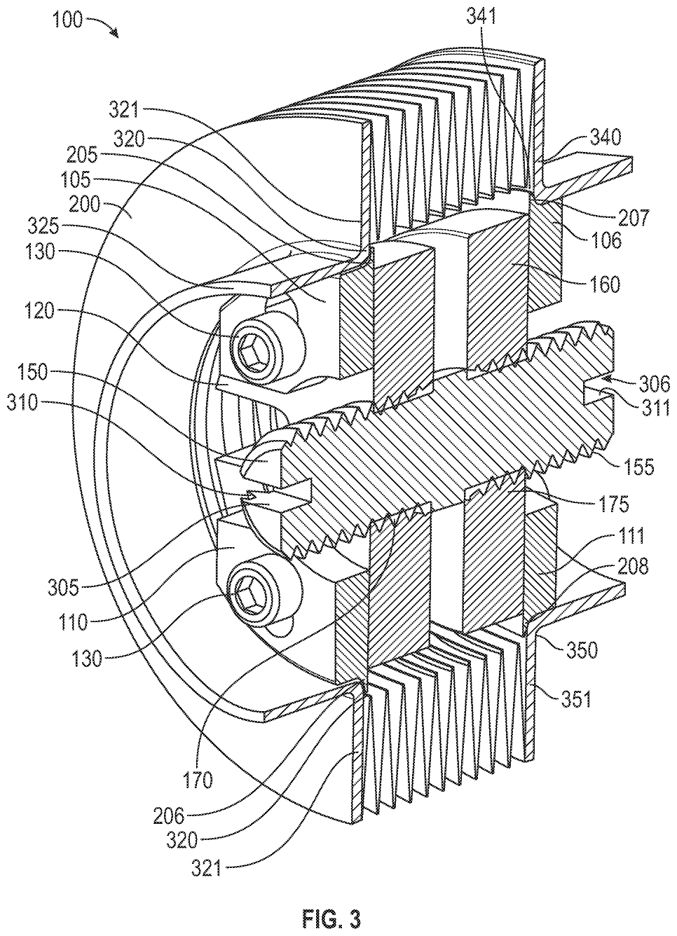

FIG. 3 illustrates additional aspects of the tool 100 in accordance with the disclosed embodiments. As illustrated, a first gripper plate 105 can be mounted to a first support plate 120 with a connector 130. Second gripper plate 110 can be mounted to the first support plate 120 with a connector 130. Likewise, a third gripper plate 106 can be mounted to a second support plate 160 with a connector 130. Fourth gripper plate 111 can be mounted to the second support plate 160 with a connector 130.

The first support plate 120 is configured with threads 170 in through hole 125. The second support plate 160 is configured with threads 175 in through hole 126. The threads 170 and threads 175 are configured to engage threads 155 configured on the separator dowel 150.

The separator dowel 150 can be configured to include a screw gap 305 on one end 310 and a second screw gap 306 on the other end 311. The separator dowel 150 can thus be rotated to increase the distance between the first support plate 120 and second support plate 160 or to decrease the distance between the first support plate 120 and the second support plate 160.

As illustrated in FIG. 3, the lip 205 on gripper plate 105 can be arranged to engage the outer most surface 320 of the bellows leaf 321 past the opening flange 325. The lip 206 on gripper plate 110 can be arranged to engage the outer most surface 330 of the bellows leaf 331. The lip 207 on gripper plate 106 can be arranged to engage the outer most surface 340 of the bellows leaf 341. The lip 208 on gripper plate 111 can be arranged to engage the outer most surface 350 of the bellows leaf 351.

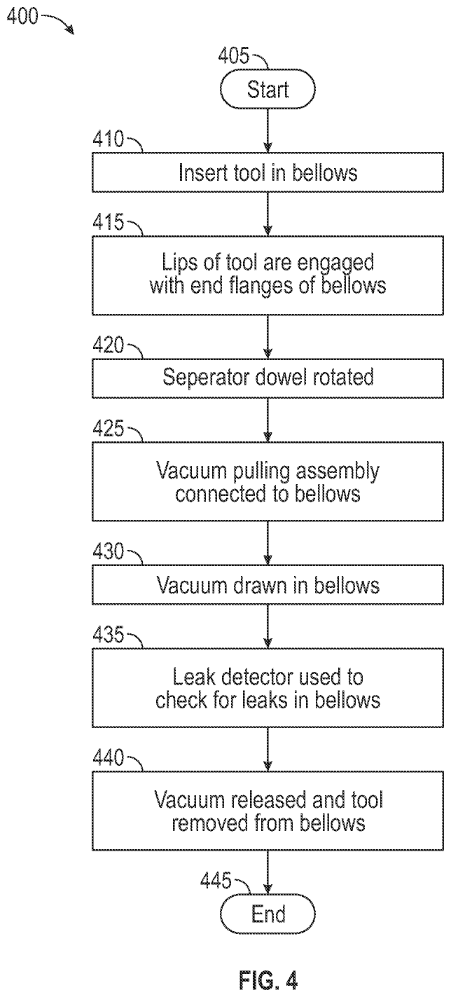

FIG. 4 illustrates steps associated with a method 400 for validating bellows vacuum integrity using a tool 100 as disclosed herein. The method 400 begins at 405.

At step 410, the tool 100 can be inserted into a bellows. In certain embodiments, the support plate 120 and the support plate 160 can be inserted in the bellows first, with the separator dowel 150 installed in the plates. Next, the gripper plate 105 can be inserted and installed on the associated support plate with connector 130, the gripper plate 110 can be inserted and installed on the support plate with another connector 130, the gripper plate 106 can be inserted and installed on the support plate with another connector 130, and the gripper plate 111 can be inserted and installed on the support plate with another connector 130. These steps can be used to effectively assemble the tool 100 inside the bellows because the assembled tool 100 may not fit past the flange 325 of the bellows. One aspect of the disclosed embodiments is that parts of the tool 100 can be assembled after it is inserted into the bellows 200.

At step 415, the lips of the tool 100 can be engaged with the leaves or rim of the bellows. In certain embodiments, this can optimally be the outer most leaves or rim of the bellows.

Next, the separator dowel can be rotated as illustrated at step 420. It is important to note that bellows can only extend to a certain length without compromising the integrity of the welds on the bellows leaves. The extension of the tool can be limited to ensure the bellow is not over extended. The rotation of the separator dowel 150 provides highly precise adjustment in the distance between the support plates, and by extension the sides of the bellows.

Once the bellows has been extended to its natural state (or desired extension), a vacuum pulling assembly can be connected to the bellows at step 425. The vacuum pulling assembly can draw a vacuum in the extended bellows at step 430. The tool prevents the bellows from collapsing when the vacuum is drawn.

A mass spectrometer leak detector can then be used to determine if any leaks are present at step 435. The vacuum can then be released, and the tool 100 can be removed from the bellows at step 440, at which point the method ends at 445.

It should be appreciated that the tool 100 can be used to validate the integrity of assemblies that have vacuum bellows already installed. The tool 100 can also be used during cleaning and/or drying processes, to help keep bellows expanded, to ease the removal of contaminates from between the leaf segments.

It should be appreciated that the tool 100 can be scaled to fit the size of the bellows which requires testing, e.g., for longer vacuum metal bellows assemblies. Likewise, the tool 100 is scalable for larger diameter cylindrical profiles, vacuum bellows assemblies.

The tool's design can be augmented for validating the integrity of oval profiles, or other viable profiles of vacuum bellows assemblies. The tool can be purposed for validating integrity of convoluted (or formed) bellows as well.

Based on the foregoing, it can be appreciated that a number of embodiments are disclosed herein. In an embodiment, a system comprises at least one first side gripper plate mounted to a first support plate, at least one second side gripper plate mounted to a second support plate, and a separator dowel configured to engage the first support plate and the second plate. In an embodiment, the separator dowel comprises a threaded dowel. In an embodiment, the at least one first gripper plate comprises two first side gripper plates. In an embodiment, the at least one second gripper plate comprises two second side gripper plates. In an embodiment, each of the first side gripper plate and the second side gripper plate comprise a lip. In an embodiment, the lip is configured to engage an interior of a bellows. In an embodiment, the system further comprises at least one connector configured to attach the at least one first side gripper plate to the first support plate and at least one connector configured to attach the at least one second side gripper plate to the second support plate. In an embodiment, rotating the separator dowel separates the first support plate and the second support plate.

In an embodiment, a validation tool comprises at least one first side gripper plate mounted to a first support plate, the first support plate comprising a female threaded receiving port, at least one second side gripper plate mounted to a second support plate, the second support plate comprising a female threaded receiving port, and a threaded separator dowel configured to engage the female threaded receiving port of the first support plate and the female threaded receiving port of the second support plate. In an embodiment, rotation of the threaded separator dowel moves the first support plate and the second support plate away from one another. In an embodiment, the at least one first gripper plate comprises two first side gripper plates, and the at least one second gripper plate comprises two second side gripper plates. In an embodiment, each of the first side gripper plate and the second side gripper plate comprise a lip configured to engage an interior of a bellows. In an embodiment, the validation tool further comprises at least one connector configured to attach the at least one first side gripper plate to the first support plate and at least one connector configured to attach the at least one second side gripper plate to the second support plate. In an embodiment, the validation tool is configured to fit inside a bellows.

In an embodiment, a method for validating bellows vacuum integrity with a tool comprises inserting a tool into a bellows, the tool comprising: at least one first side gripper plate mounted to a first support plate, the first support plate comprising a female threaded receiving port, at least one second side gripper plate mounted to a second support plate, the second support plate comprising a female threaded receiving port, and a threaded separator dowel configured to engage the female threaded receiving port of the first support plate and the female threaded receiving port of the second support plate; expanding the bellows with the tool; drawing a vacuum in the bellows; and identifying leaks in the bellows. In an embodiment, expanding the bellows with the tool comprises rotating the threaded separator dowel. In an embodiment, identifying leaks in the bellows comprises identifying leaks in the bellows with a mass spectrometer leak detector. In an embodiment, the method for validating bellows vacuum integrity with a tool further comprises engaging a lip of the tool onto an interior of the bellows. In an embodiment, the method for validating bellows vacuum integrity with a tool further comprises releasing the vacuum inside the bellows. In an embodiment, the method for validating bellows vacuum integrity with a tool further comprises removing the tool from the bellows.

It will be appreciated that variations of the above-disclosed and other features and functions, or alternatives thereof, may be desirably combined into many other different systems or applications. Also, various presently unforeseen or unanticipated alternatives, modifications, variations, or improvements therein may be subsequently made by those skilled in the art which are also intended to be encompassed by the following claims.

What is claimed is:

1. A system comprising:
at least one first side gripper plate mounted to a first support plate;
at least one second side gripper plate mounted to a second support plate; and
a separator dowel configured to engage the first support plate and the second plate.

2. The system of claim 1 wherein the separator dowel comprises a threaded dowel.

3. The system of claim 1 wherein the at least one first gripper plate comprises:
two first side gripper plates.

4. The system of claim 1 wherein the at least one second gripper plate comprises:
two second side gripper plates.

5. The system of claim 1 wherein each of the first side gripper plate and the second side gripper plate comprise a lip.

6. The system of claim 5 wherein the lip is configured to engage an interior of a bellows.

7. The system of claim 1 further comprising:
at least one connector configured to attach the at least one first side gripper plate to the first support plate; and
at least one connector configured to attach the at least one second side gripper plate to the second support plate.

8. The system of claim 1 wherein rotating the separator dowel separates the first support plate and the second support plate.

9. A validation tool comprising:
at least one first side gripper plate mounted to a first support plate, the first support plate comprising a female threaded receiving port;
at least one second side gripper plate mounted to a second support plate, the second support plate comprising a female threaded receiving port; and
a threaded separator dowel configured to engage the female threaded receiving port of the first support plate and the female threaded receiving port of the second support plate.

10. The validation tool of claim 9 wherein rotation of the threaded separator dowel moves the first support plate and the second support plate away from one another.

11. The validation tool of claim 9 wherein the at least one first gripper plate comprises two first side gripper plates, and the at least one second gripper plate comprises two second side gripper plates.

12. The validation tool of claim 9 wherein each of the first side gripper plate and the second side gripper plate comprise a lip configured to engage an interior of a bellows.

13. The validation tool of claim 9 further comprising:
at least one connector configured to attach the at least one first side gripper plate to the first support plate; and
at least one connector configured to attach the at least one second side gripper plate to the second support plate.

14. The validation tool of claim 9, wherein the validation tool is configured to fit inside a bellows.

15. A method for validating bellows vacuum integrity with a tool comprising:
inserting a tool into a bellows, the tool comprising:
at least one first side gripper plate mounted to a first support plate, the first support plate comprising a female threaded receiving port;
at least one second side gripper plate mounted to a second support plate, the second support plate comprising a female threaded receiving port; and
a threaded separator dowel configured to engage the female threaded receiving port of the first support plate and the female threaded receiving port of the second support plate;
expanding the bellows with the tool;
drawing a vacuum in the bellows; and
identifying leaks in the bellows.

16. The method for validating bellows vacuum integrity with a tool of claim 15 wherein expanding the bellows with the tool comprises:
rotating the threaded separator dowel.

17. The method for validating bellows vacuum integrity with a tool of claim 15 wherein identifying leaks in the bellows comprises:
identifying leaks in the bellows with a mass spectrometer leak detector.

18. The method for validating bellows vacuum integrity with a tool of claim 15 further comprising:
engaging a lip of the tool onto an interior of the bellows.

19. The method for validating bellows vacuum integrity with a tool of claim 15 further comprising:
releasing the vacuum inside the bellows.

20. The method for validating bellows vacuum integrity with a tool of claim 19 further comprising:
removing the tool from the bellows.
